(19) United States
(12) Patent Application Publication
(10) Pub. No.: US 2004/0140973 A1
(43) Pub. Date: Jul. 22, 2004

(54) System and method of a video capture monitor concurrently displaying and capturing video images

(76) Inventor: Farouk M. Zanaty, Loveland, CO (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/345,334

(22) Filed: Jan. 16, 2003

(51) Int. Cl. H04N 5/335

(52) U.S. Cl. 345/214

(57) ABSTRACT

An apparatus and method of a video capture monitor includes pixels to display information on the video capture monitor and to capture an image of with the video capture monitor.

### BACKGROUND OF THE INVENTION

An LCD or plasma (i.e., flat panel) monitor or screen of a computer (e.g., desktop, laptop, palmtop, handheld, etc.) is divided into columns and rows. Each column and row is divided into pixels and each pixel includes R (red), G (green), and B (blue) picels. A screen resolution determines a size and a number of pixels that display information on the monitor. A main function of the pixels is to display in different colors, brightness, and times the information.

A typical video camera records video signals as a series of alternating fields: an odd field followed by an even field, for example. One odd field plus one even field constitutes a frame of the video signal. At a frame rate of thirty frames per second, each field is thus captured in successive time periods of 1/60th of a second. Thus, if the odd field of a frame is captured in a first time period, the even field is captured in a second time period, 1/60th of a second later. Further, in most computer monitors, the frame of an image is displayed by starting from a top left corner of the frame, and, scanning from left to right, displaying each line of the image onto the computer screen, from the first to the last line, until the entire image has been displayed on the screen.

A progressive scan video camera likewise records each frame of the image by scanning the frame from left to right, for each line, and scanning from top to bottom the entire frame. A camera of this type typically records sixty frames in a second. Accordingly, recording the image in this manner is well-suited for ultimate display on the computer monitor.

Furthermore, it is possible for a video signal recorded in an interlaced fashion to be displayed on the computer monitor. Likewise, it is possible for a progressively scanned video signal to be displayed on a television screen. An interlaced video data stream typically transmits at 60 fields/second. A progressive data stream typically transmits at 60 frames/second, which is twice the rate of the interlaced video data stream. If a progressive video signal is interlaced in order to combine with other interlaced video signals, the interlacing may introduce undesirable noises into the resulting image. This is particularly true for graphics images, which are higher frequency in nature than video signals, which drive an interlaced television. This form of combining is, thus, inadequate for many real-time applications.

Thus, a need exists for an apparatus and method thereof providing image display signals interlaced with a video signal acquired simultaneously or in a synchronized manner with the image display signals without unduly degrading the signals and without using a separate video camera or the like.

### SUMMARY OF THE INVENTION

Various aspects and advantages of the invention will be set forth in part in the description that follows and, in part, will be obvious from the description, or may be learned by practice of the invention.

In accordance with an aspect of the present invention, there is provided a video capture monitor, including pixels displaying information on the video capture monitor and capturing an image with the video capture monitor.

In accordance with an aspect of the present invention, there is provided a video capture monitor, including pixels displaying R (Red), G (Green), and/or B (Blue) colors of information at different intensities in alternating pixel rows or columns, wherein each pixel includes four picels, where three picels provide red, green, and blue colors to display the information on the video capture monitor and a fourth picel (capture picel) captures an image with the monitor.

In accordance with an aspect of the present invention, there is provided a video capture monitor displaying information and capturing an image of with the video capture monitor, including a scanner/color decoder determining R (Red), G (Green), and/or B (Blue) picel values and color distribution of the information to be displayed; a trigger/time reference triggering time sequences to control the pixel rows and columns in the video capture monitor to display the information; a projection-on-screen and capturing picels circuit capturing the image with the video capture monitor; a photoarray color resolution (R, G, B) circuit breaking the captured image into RGB components; and a display/capture scheme receiving the RGB picel values of the information to be displayed and the RGB components of the captured image to display the information and the captured image.

In accordance with an aspect of the present invention, there is provided a method of a video capture monitor, including displaying information on the video capture monitor and capturing an image with the video capture monitor using pixels of the video capture monitor, wherein at some instant of time, some pixels function in a display mode where information is being displayed, and other pixels function in a capture mode where the image is captured.

In accordance with an aspect of the present invention, there is provided a method of for capturing video information with a monitor, including: determining R (Red), G (Green), and/or B (Blue) picel values and color distribution of information to be displayed; triggering time sequences to control the pixel rows and columns in the monitor to display the information; capturing the image with the monitor; breaking the captured image into RGB components; and receiving the RGB picel values of the information to be displayed and the RGB components of the captured image to display the information and the captured image.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

The above and other objects, features and other advantages of the present invention will be more clearly understood from the following detailed description taken in conjunction with the accompanying drawings, in which:

FIGS. 1A and 1B illustrate a pixel and four consecutive pixels, each pixel including at least four picels, in accordance with an aspect of the present invention;

FIG. 2 illustrates a controller of a flat panel video capture monitor, in accordance with an aspect of the present invention;

FIG. 3 illustrates a control circuit diagram of a display/capture system of the video capture monitor, in accordance with an aspect of the present invention;

FIG. 4 illustrates a method to process information to be displayed and to process an image captured by the interlace monitor, in accordance with an aspect of the present invention;

FIG. 5 illustrates a display of the video capture monitor, in accordance with an aspect of the invention;

FIG. 6A illustrates a scheme where pixels of the video capture monitor are displaying information and capturing an image in an alternating sequence, in accordance with an aspect of the present invention;

FIG. 6B illustrates in detail two pixel rows of the scheme shown in FIG. 6A;

FIG. 6C illustrates time samples of the scheme shown in FIG. 6A, were a display mode and a capture mode alternate between pixels, in accordance with an aspect of the present invention;

FIG. 7 illustrates odd pixel rows of the video capture monitor being in the display mode and even pixel rows in the capture mode, in accordance with an aspect of the present invention;

FIG. 8A illustrates odd pixel columns of the video capture monitor being in the capture mode and even pixel columns being in the display mode, in accordance with an aspect of the present invention;

FIG. 8B illustrates sample times t1 to t4 of the odd pixel rows of the video capture monitor being in the display mode and the even pixel rows being in the capture mode, in accordance with an aspect of the present invention;

FIG. 8C illustrates the odd pixel rows of the video capture monitor displaying a combination of RGB picels displaying the information and a capture picel capturing the image, in accordance with an aspect of the present invention;

FIGS. 8D and 8E illustrate a timing diagram of the scheme shown in FIG. 8C;

FIG. 9 illustrates a scheme where, for each row, a consecutive number of pixels are randomly selected to be in the capture mode and a consecutive number of pixels are randomly selected to be in the display mode, in accordance with an aspect of the present invention;

FIG. 10 illustrates the video capture monitor being in the capture mode, in accordance with an aspect of the present invention;

FIG. 11 illustrates the video capture monitor being in the display mode, in accordance with an aspect of the present invention; and

FIG. 12 illustrates a display/capture method, in accordance with an aspect of the present invention.

### DETAILED DESCRIPTION OF THE PREFERRED EMBODIMENTS

Hereinafter, aspects of the present invention will be described in detail with reference to the attached drawings. The present invention may, however, be embodied in many different forms and should not be construed as being limited to the aspects set forth herein; rather, these aspects are provided so that the present disclosure will be thorough and complete, and will fully convey the concept of the invention to those skilled in the art.

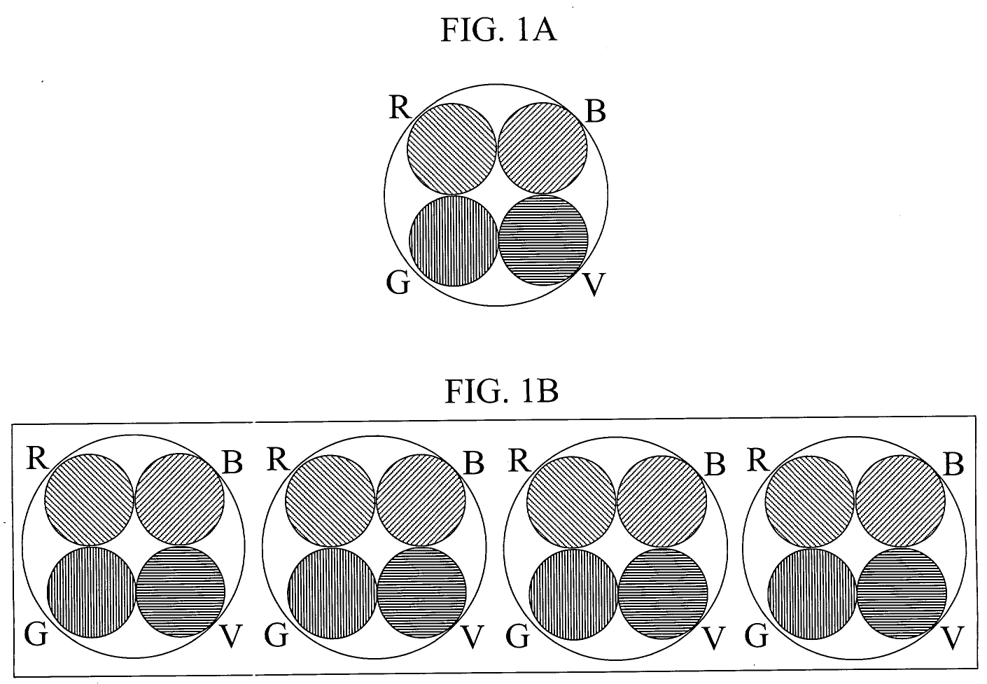

Referring to FIGS. 1A and 1B, in accordance with an aspect of the present invention, a pixel is defined as including four picels. A picel, in accordance with an aspect of the present invention, refers to a predetermined number of components in a pixel, each having a function of displaying a color component or capturing a video or image component. Thus, three of the picels are used to display the R (Red), G (Green), and B (Blue) colors (i.e., RGB picels) displayed (i.e., a display mode) at different intensities according to an image to be displayed or program information. The fourth picel, V (i.e., a video or capture picel), is used to capture a video image or data of a target with a video capture monitor (i.e., a capture mode) by projecting and capturing light arrays to/from the target, such as a user. Accordingly, the pixel is referred to as an RGBV pixel. FIGS. 1A and 1B show the RGBV pixel and four consecutive RGBV pixels. Although many different resolutions can be utilized within the scope of the present invention, an implementation may utilize a monitor having 1280 pixel columns by 1024 pixel rows of RGB and capture picels.

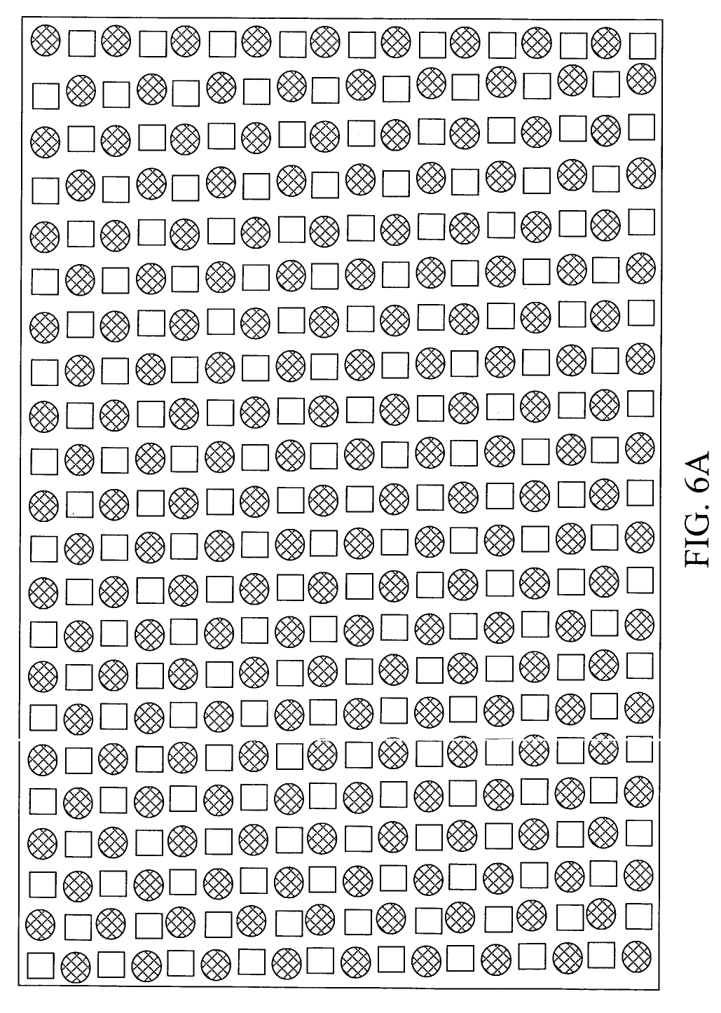

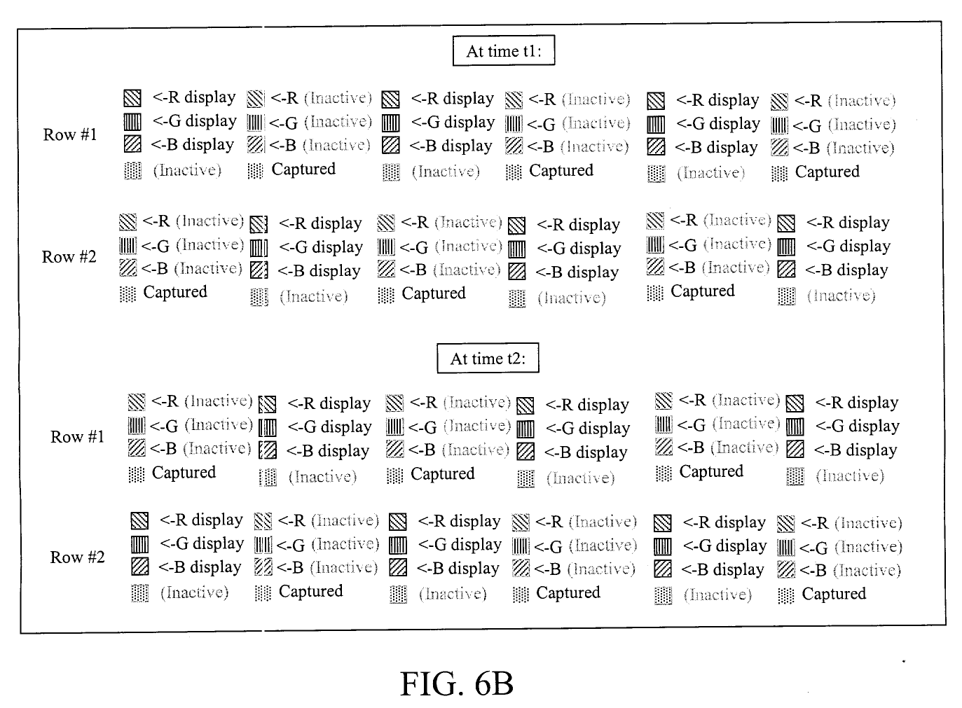

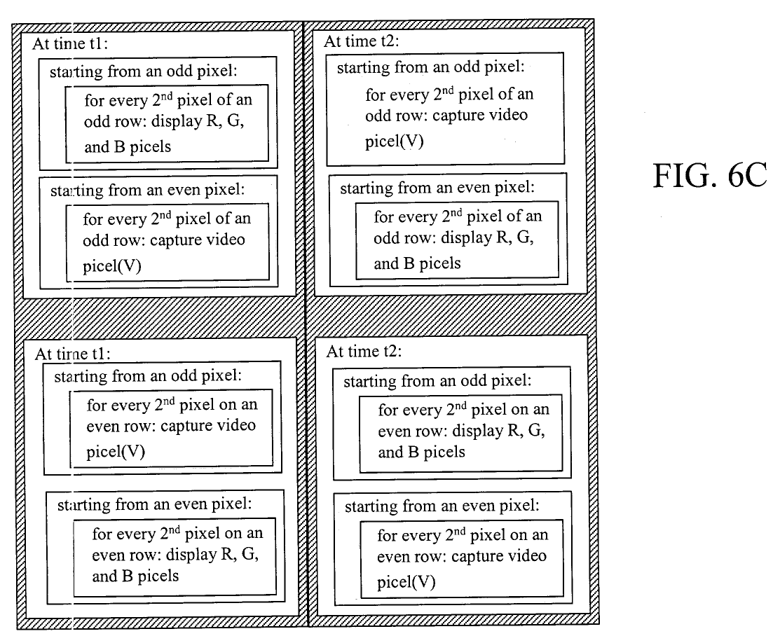

Specifically, in typical image monitors, each pixel is turned-on in a sequential order per column and per row. However, if each pixel is turned-on in the sequential order to display the information and to capture image or data at a same time, noise or interference may occur between displaying and capturing the data. Accordingly, an apparatus and method are needed to display and capture data using a single LCD or plasma monitor and to redefine a display/capture data sequence. The apparatus and the method, in accordance with an aspect of the present invention, redefine an interlacing sequence to display and capture data signals. In particular, the interlacing sequence can be achieved by different schemes, which will be discussed in detail with reference to FIGS. 6A to 11. For instance, a scheme may provide that every odd pixel in a row to be displaying data (i.e., the display mode) and every even pixel in the same row to be capturing data (i.e., the capture mode). Further, another scheme may provide that pixels in each row of the screen would be randomly selected by a controller in a computer to be in the display mode or in the capture mode.

Internal electronic arrays that correspond to the pixels are to be changed to perform the dual functions, i.e., the display mode and the capture mode. The acquired image of a face of the person is to be used for real time transmission or display without a need for a PC external camera, for instance. The monitor or screen of the computer that possesses the newly defined functions will be referred to as the video capture monitor. Specifically, the video capture monitor is defined as a monitor or screen capable of capturing an image before the monitor or the screen and displaying information on the monitor or the screen.

An aspect of the present invention allows the video capture monitor to display and capture program and image information without showing image noise or disturbance. The video capture monitor complies with North American or European standards where 25-35 frames per second are projected in full motion.

As previously set forth, each pixel, according to an embodiment of the present invention, includes four picels. Three picels are the conventional RGB picels to display information on the screen. The fourth picel is an added video picel component for each pixel. Specifically, each pixel can be considered as a video camera. A circuitry to operate the video picel, for instance, may be conceptually identical to circuitries of well-known video cameras except that in the present invention, there are m×n cameras (i.e., m×n video picels), where m is a number of rows and n is a number of columns. In one aspect according to the present invention, a construction of the fourth picel would be to add a fourth phosphoric component with a transparent color to the RGB picels of each pixel of a CRT screen.

In the display mode, an amount of current hitting phosphors of the CRT screen causes the phosphors to emit light proportional with the amount of current and, therefore, the intensity of the RGB colors would vary (i.e., red, green, or blue). In the video capture mode of the fourth phosphoric component acts as a lens projecting light directly on a corresponding photoelectronic array element that resolves the projected light of the target into a corresponding color and intensity for display.

In another aspect according to the present invention, the construction of the fourth picel would be to add a photosensitive sheet with rectangular cells each containing four subcells. Three of the subcells would be transparent without affecting the projected RGB colors and corresponding intensities. The fourth subcell would be an active photodetection element that detects the color (similar to films in photography) and the intensity of the projected light of the target for display. The photosensitive sheet can then be sensed horizontally and vertically along each edge with variable coordinates (x-y) to detect the color and the intensity of each picel.

Furthermore, in the case of a plasma screen, it is well-known that plasma screens are arrays of cells where gas in the plasma is used to react with phosphors of each picel to display the RGB colors. The fourth picel may be added where the phosphoric reaction is neutralized (disabled). The fourth picel then would act as a lens. The controller 10 would send to the RGB picels control signals to control the intensity of the RGB colors and would receive signals from the neutralized picel that pass through the photoelectronic array to be resolved to RGB components representative of the projected light array of the target.

In addition, focusing of the captured image of the target may be performed electronically and by processing the captured image. Unlike the well-known “optical” focusing where an optical lens that inverts the projected image and focuses the projected image depends on a distance between the target and a focal lens, the image captured by the fourth picel is electronically focused and processed. The function of the fourth picel of capturing the image may be analogous to a projection on a mirror when there is no lens. The projected image's parallel arrays are reflected from the mirror at every video picel of the infinite resolution of the mirror.

A photoelectronic sheet may be used to function as the mirror to capture the entire image of the target. The photoelectronic sheet may be divided into small squares including four spaces for the four picels. Three spaces would be designated for the three picels and a fourth space would be designated for the capture picel, which may be electro-photo sensitive such that the distribution of all horizontal and vertical picels can be connected along edges of the photoelectronic sheet. A printed circuit includes horizontal and vertical conductors with no intersection that may be used where a combination of the horizontal and vertical conductors performs a matrix with each picel being uniquely identified by corresponding coordinates. The photoelectronic array controller to detect the color and intensity of every capture picel can then use the coordinates. However, the mirror does not focus but reflects parallel arrays to be focused by the receiving eye. A rectangular area of the screen where the capture picels are equally distributed, acts as a capturing mirror to gather the projected array elements of the target (color and intensity) at every picel.

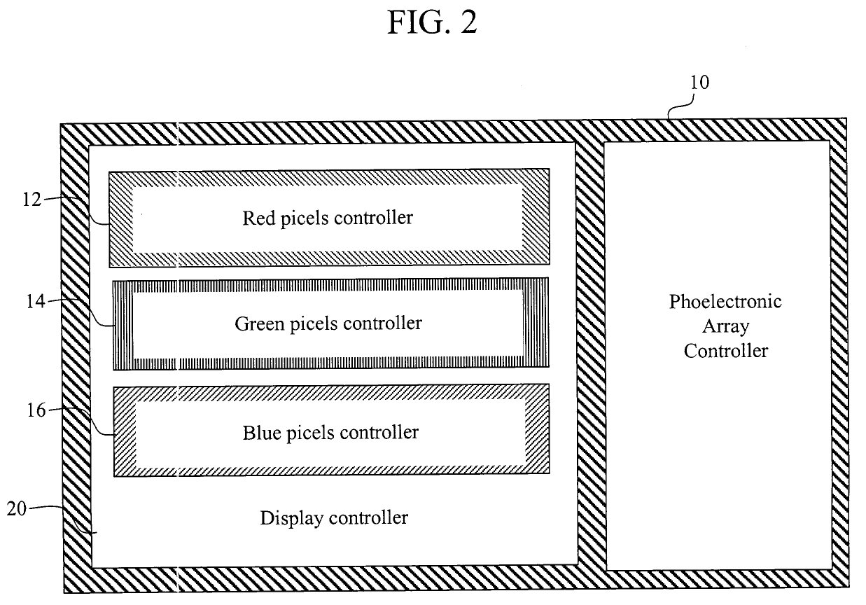

FIG. 2 illustrates a controller 10 of the interlaced LCD or plasma (i.e., flat panel) monitor, in accordance with an aspect of the present invention. The controller 10 may include an application-specific integrated circuit (ASIC). Specifically, the hardware included in the controller 10 includes memories, processors, and/or ASICs. Such memory includes a machine-readable medium on which is stored a set of instructions (i.e., software) embodying any one, or all, of the methodologies described herein. Software can reside, completely or at least partially, within this memory and/or within the processor and/or ASICs. For the purposes of this specification, the term “machine-readable medium” shall be taken to include any mechanism that provides (i.e., stores and/or transmits) information in a form readable by a machine (e.g., a computer). For example, a machine-readable medium includes read only memory (“ROM”), random access memory (“RAM”), magnetic disk storage media; optical storage media, flash memory devices, electrical, optical, acoustical, or other form of propagated signals (e.g., carrier waves, infrared signals, digital signals, etc.).

The controller 10 would capture the image of the target before the computer and/or display the information processed by the computer of transmitted from a network. Although FIG. 2 illustrates a controller 10 to process the captured image and/or to display the information, in an alternative aspect, multiple controllers may be used to process the capture and display modes. The controller 10 includes a red picels controller 12, a green picels controller 14, and a blue picels controller 16 to control the red, green, and blue picels, respectively, of the pixels of the video capture monitor. A photoelectronic array controller 18 controls the capture picels of the video capture monitor. Further, a display controller 20 controls all controllers 12, 14, 16, 18.

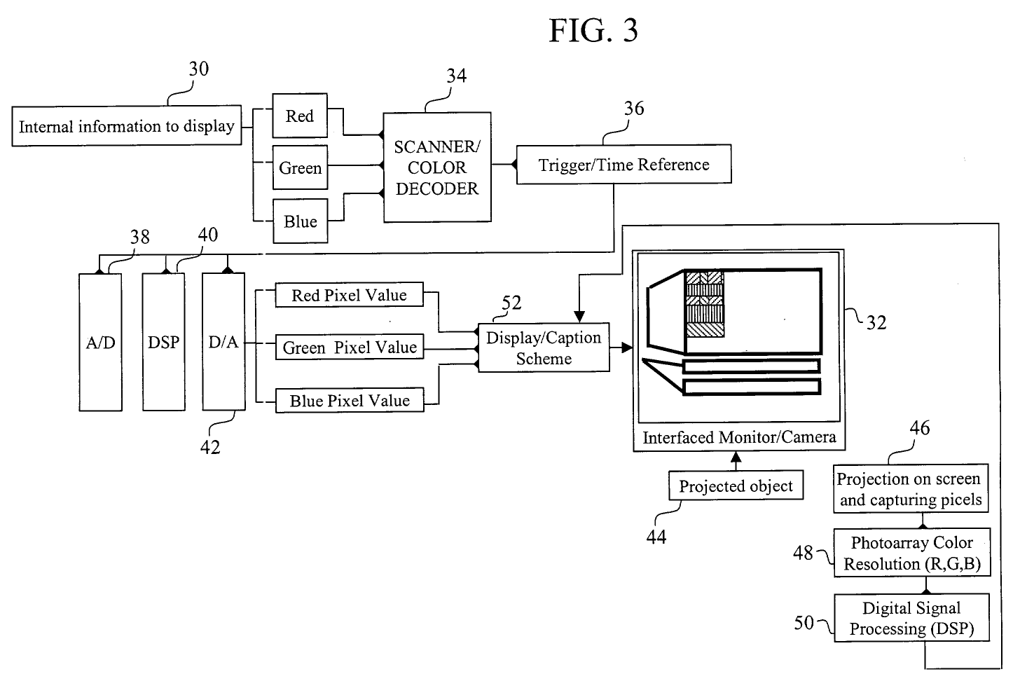

Referring to FIG. 3, a control circuit diagram is shown of a display/capture system of the video capture monitor, in accordance with an aspect of the present invention. An internal information to display circuit 30 provides the information to be displayed on the video capture monitor 32. The information may include data, images, or the like. The information to be displayed is broken into red, green, and blue components and transferred to a scanner/color decoder 34 to determine red, green, and blue picel values and color distribution (i.e., intensity). A trigger/time reference 36 triggers time sequences to control the pixel rows and columns of the video capture monitor 32 to display the information. An analog-to-digital A/D converter 38 converts output signals from the trigger/time reference 36 to digital signals. A digital signal processing (DSP) 40 receives the digital signals and processes the signals. A digital-to-analog D/A converter 42 converts the processed signals to analog signals and generates a red picel value, a green picel value, and a blue picel value.

In turn, the video capture monitor 32 captures a projected object or the image 44. A projection-on-screen and capturing picels circuit 46 receives and processes the captured image from the user and a photoarray color resolution (R, G, B) circuit 48 breaks the captured image into RGB components. A digital signal processing (DSP) 50 receives and processes the RGB components. A display/capture scheme 52 receives the red, green, and blue picel values of the information to be displayed and the RGB components of the captured image from the DSP 50 and displays the information and the captured image using one of the schemes to be set forth in FIGS. 6A to 11. The display/capture scheme 52 includes the controller 10 of FIG. 2 to process the information to be displayed using the RGB picels, and to process the image captured of the user or object before the video capture monitor 32 using the photoelectronic array controller 18. Accordingly, the video capture monitor 32 displays the information and captures the image. The video capture monitor 32 resolves the captured image to equivalent RGB components and makes the image available to be saved in files or to be uploaded to a remote monitor over the network such as the Internet.

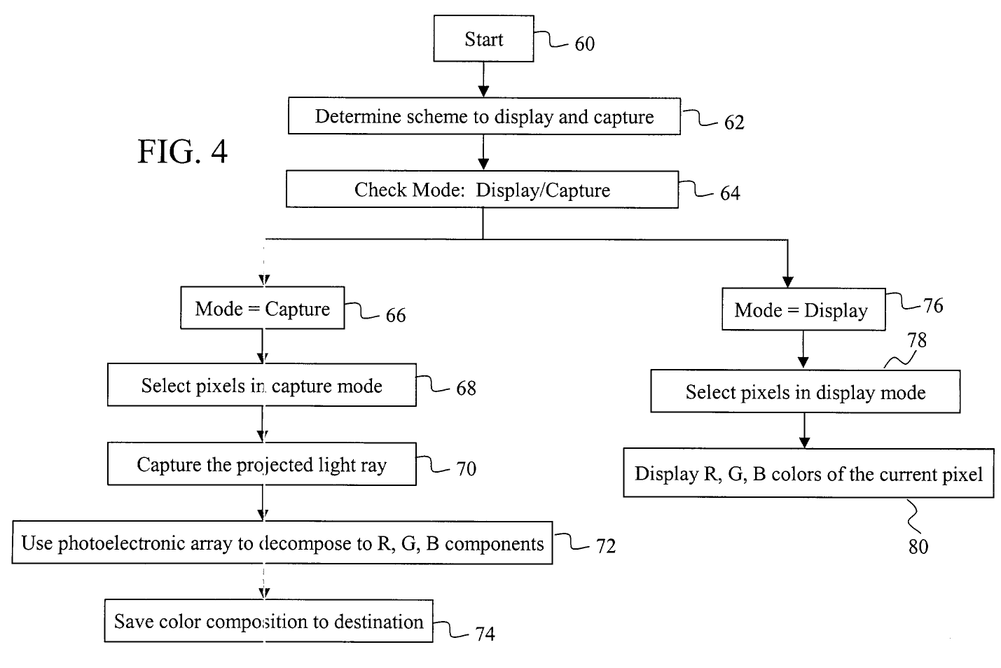

FIG. 4 illustrates a method to process the information to be displayed and to process the image captured by the interlace monitor 32. At operation 60, the method starts and, at operation 62, a determination is made whether the capture mode is enabled and the scheme is defined that is to be used to display the information and to capture the image. At operation 64, a functionality of each pixel of the video capture monitor 32 is defined as either functioning in the display mode or in the capture mode. At operation 66, the capture mode is processed. At operation 68, based on the scheme defined, the pixel rows and columns are selected that have the capture picel enabled or active (i.e., capture mode). At operation 70, the projected light ray is captured associated with the image in front of the video capture monitor 32. At operation 72, the photoarray color resolution (R, G, B) 18 is used to decompose the captured image into R, G, and B components. At operation 74, a color composition based on the R, G, and B components is transmitted to a remote location (e.g., another video capture monitor) via the network or saved into a file. At operation 76, the display mode is processed. At operation 78, based on the scheme defined, the pixel rows and columns are selected that have the RGB picels enabled or active (i.e., display mode). At operation 80, the information is displayed based on the R, G, and B components associated therewith.

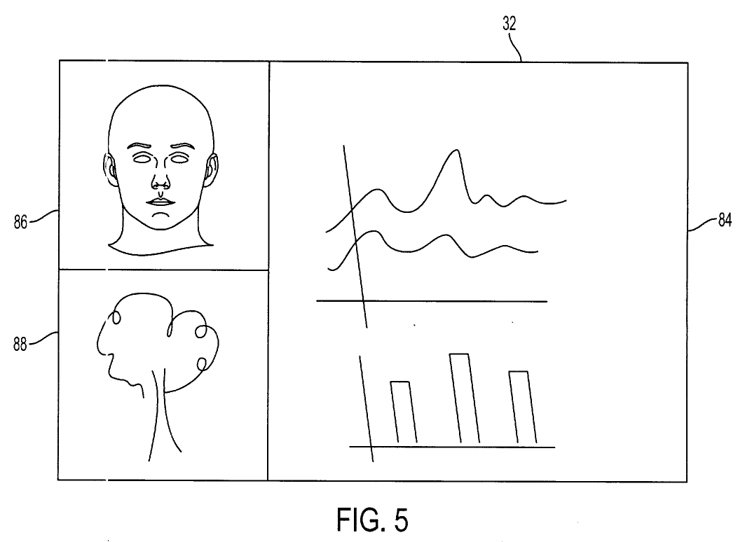

Once the video capture monitor captures the image of the user, for instance, the image may be uploaded and distributed over the network. In one aspect of the invention, assuming that multiple users are connected to the network, the video capture monitor 32 would allow each user to transmit his or her image to other users and to display the images of other users. That is, the video capture monitor 32 would allow the users to transmit and display information while viewing each other's images. Further, the video capture monitor 32 may allow the user to direct the video capture monitor 32 to capture the image of a specific target other than the user and transmit to and display such a target on remote video capture monitors connected to the network. Naturally, the user directing the video capture monitor to the specific target may simultaneously view that target himself or herself on the video capture monitor 32 with the remote video capture monitors. For instance, as shown in FIG. 5, in one portion of a local video capture monitor, information is displayed such as graphs 84, and in another portion of the local video capture monitor, an image 86 from one of the remote users is displayed, which is captured by another video capture monitor at a remote location and sent across the network to the local video capture monitor for display. Further, the local video capture monitor, in accordance with an aspect of the present invention, may be a portable personal computer that the user would position to capture the image of a specific target 88, such as a tree, for instance, and transmits the captured image to the remote video capture monitors connected to the network, as well as, displays the captured image of the tree on another portion of the local video capture monitor.

FIGS. 6A to 11 illustrate various scheme configurations at a predetermined time that may be used for the video capture monitor 32 to function in the display mode and/or in the capture mode. For ease of understanding, shaded circles and light squares are used to represent the pixels of the video capture monitor 32. The circles represent the pixels displaying information (i.e., the display mode) and the squares represent the pixels capturing the image (i.e., the capture mode). FIG. 6A illustrates a scheme where the pixels of the video capture monitor are displaying information and capturing images in an alternating sequence. FIG. 6B illustrates in detail two pixel rows of the scheme shown in FIG. 6A. That is, at time t1, the odd pixels in odd pixel rows of the video capture monitor 32 and the even pixels in even pixel rows of the video capture monitor are in the display mode (i.e., the RGB picels are active). In turn, at time t1, the even pixels in the odd pixel rows and the odd pixels in the even pixel rows are in the capture mode (i.e., capturing picel is active). At time t2, the opposite of time t1 occurs, where the even pixels in the odd pixel rows and the odd pixels in the even pixel rows are in the display mode, and the odd pixels in the odd pixel rows and the even pixels in the even pixel rows are in the capture mode.

FIG. 6C illustrates time samples of the scheme shown in FIG. 6A where the display mode and the capture mode alternate between pixels. In particular, FIG. 6C illustrates that at time t1, in the odd pixel rows of the video capture monitor 32, the odd pixels function in the display mode and the even pixels function in the capture mode. Further, at time t1, in the even pixel rows, the odd pixels function in the capture mode and the even pixels function in the display mode. That is, the RGB picels of the odd pixels of the odd pixel rows and of the even pixels of the even pixel rows of the video capture monitor 32, are displaying the R (Red), G (Green), and/or B (Blue) colors at different intensities of the displayed image or program information and the capture picel (fourth picel) is inactive. Further, the capture picel of the even pixels of the odd pixel rows and of the odd pixels of the even pixel rows is capturing data from the target and the RGB picels are inactive.

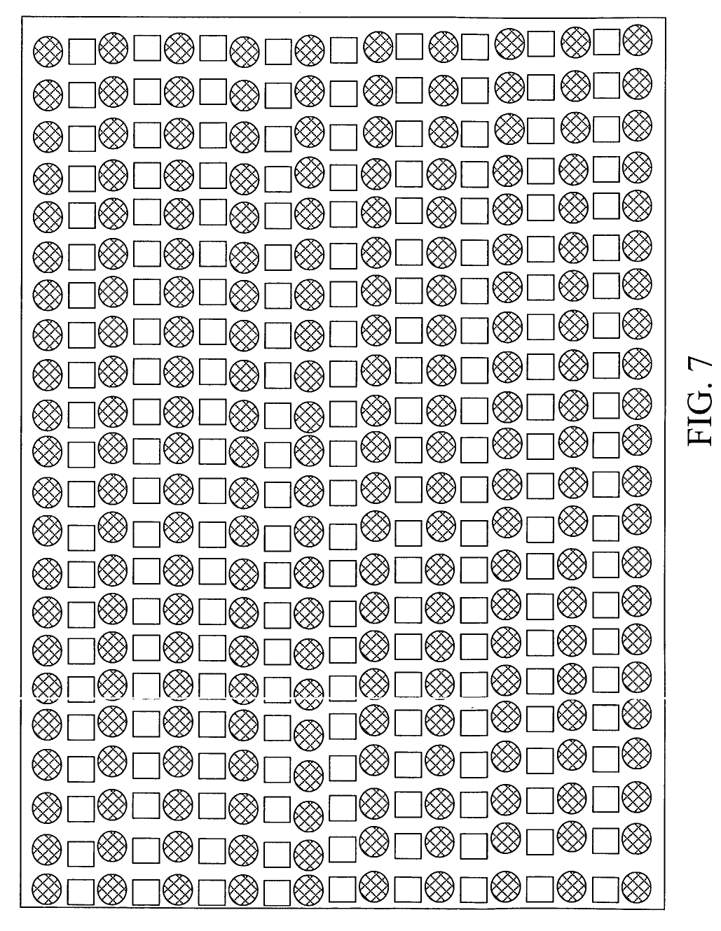

At time t2, the functions of the pixels of the video capture monitor alternate from the functions at time t1. Specifically, at time t2, in the odd pixel rows of the video capture monitor 32, the odd pixels function in the capture mode and the even pixels function in the display mode. Further, at time t2, in the even pixel rows, the odd pixels function in the display mode and the even pixels function in the capture mode. At times t3 and t4, not shown, the pixels of the video capture monitor alternate functions once again as illustrated at time t1 and t2, respectively. FIG. 7 illustrates the odd and even pixel rows of the video capture monitor 32 alternating between the display mode and the capture mode, respectively.

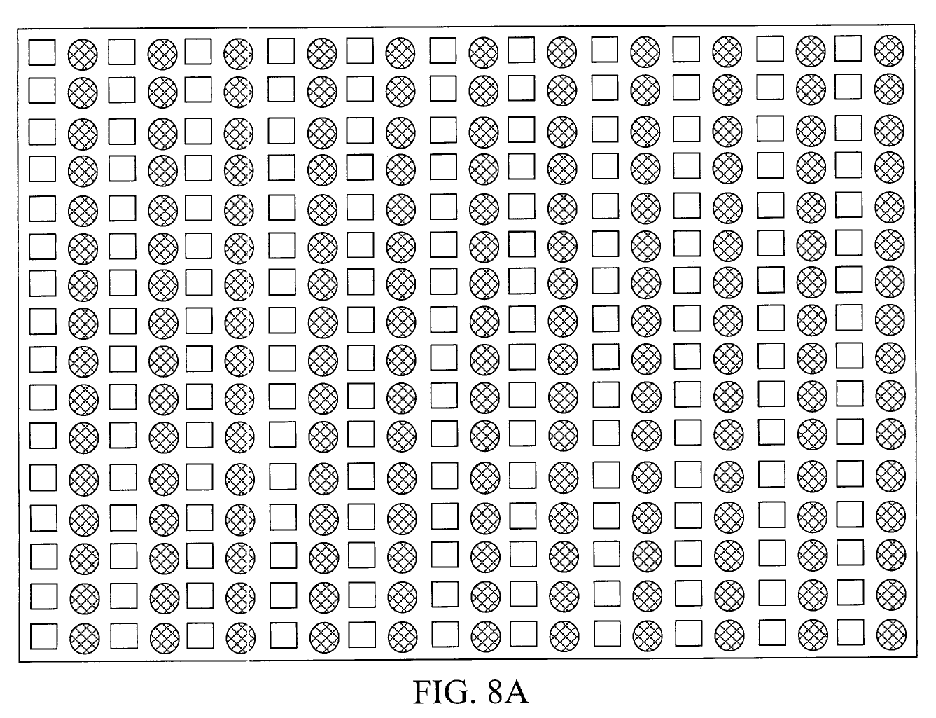

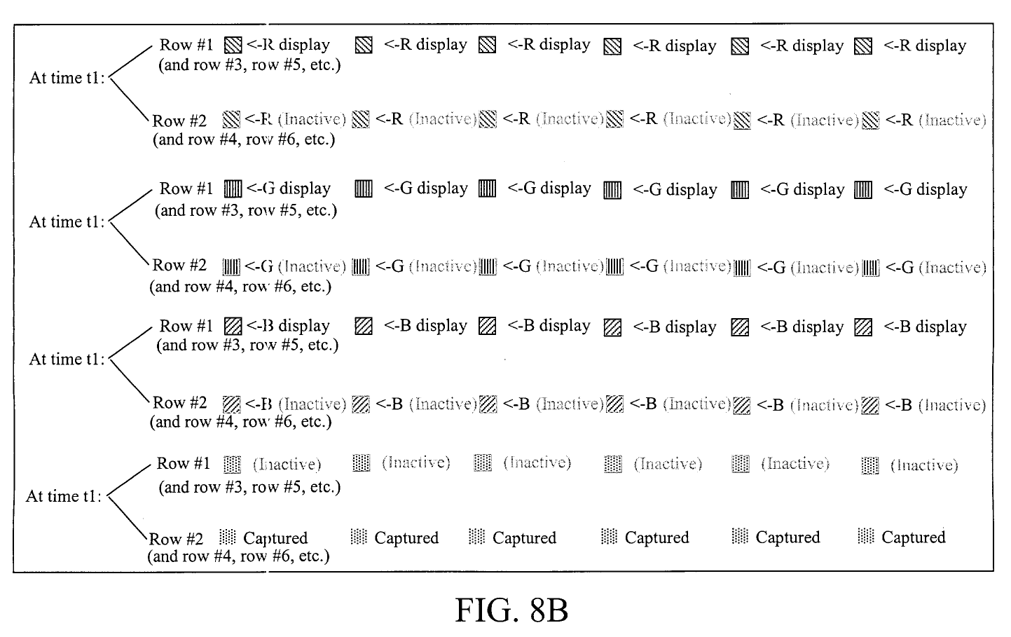

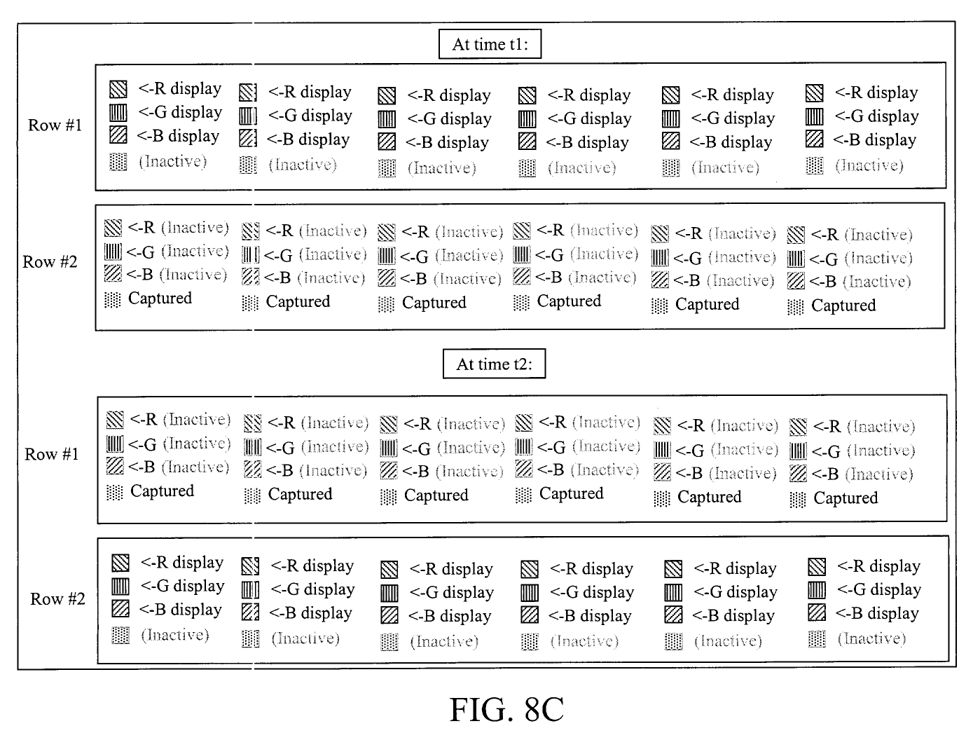

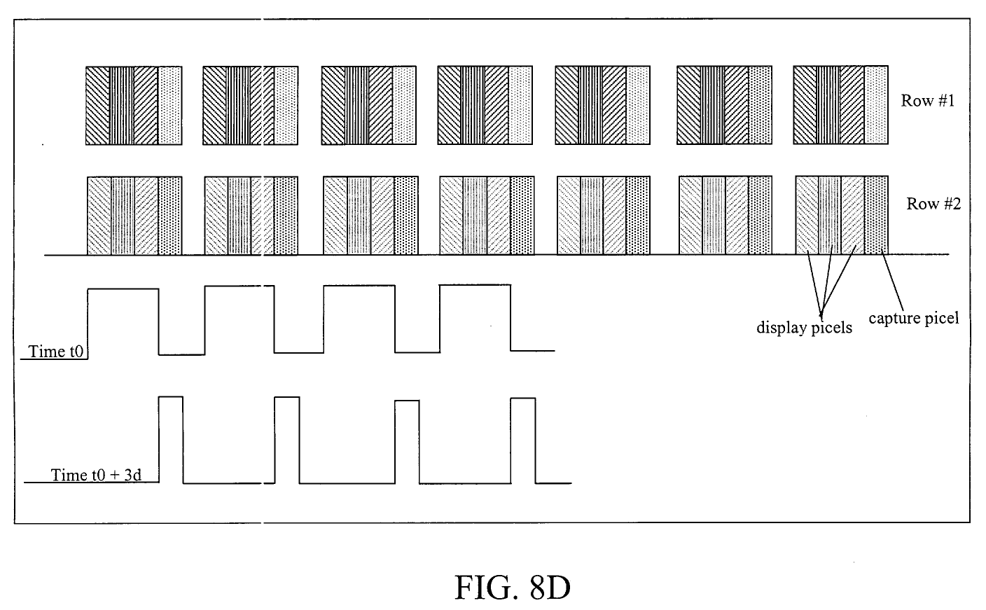

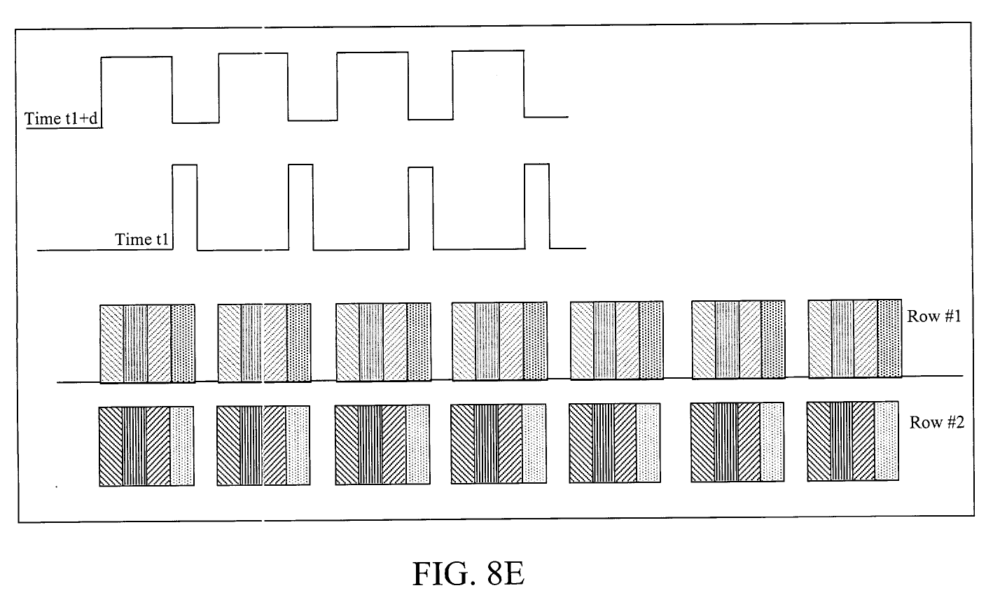

FIG. 8A illustrates the odd pixel columns of the video capture monitor 32 being in the capture mode and the even pixel columns being in the display mode. FIG. 8B illustrates times t1 to t4 of the odd pixel rows of the video capture monitor 32 being in the display mode and the even pixel rows being in the capture mode (i.e., the RGB picels are inactive). At times t1 to t3 the even pixel rows are inactive. Specifically, at time t1, the pixels of the odd pixel rows are displaying the red picel only, and, at time t2, the pixels of the odd pixel rows are displaying the green picel only. At time t3, the pixels of the odd pixel rows are displaying the blue picel only and, at time t4, the odd pixel rows are inactive and the even pixel rows are activated to capture information, that is, the capture or video picel is active. Accordingly, at time t4, the interactive monitor is capturing information only rather than displaying. In an alternative aspect of the present invention, FIG. 8C illustrates that at time t1, the odd pixel rows of the video capture monitor 32 display a combination of the RGB picels and the even pixel rows capture information; that is, in the even pixel rows, the capture picel of the pixels are active and the RGB picels are inactive. At time t2, the function of the odd and even pixel rows reverse. That is, the odd pixel rows capture information and the even pixel rows of the video capture monitor 32 display the combination of the RGB picels; that is, in the odd pixel rows, the capture picel of the pixels are active where the RGB picels are inactive. At time t3 (not shown), the function of displaying and capturing information of the odd and even pixel rows reverse once again to repeat the functions shown at time t1.

FIG. 8D illustrates a timing diagram of the scheme shown in FIG. 8C at time t1. Row #1 displays the four picels for each pixel in that row. At time t0, a first pulse train signal is triggered where a width of the pulse is long enough to activate only the RGB picels in row #1. At time t0+3d, where 3d is the width of the pulse of the first train signal where the RGB picels are active, a second pulse train signal is triggered where a width of the pulse is long enough to activate only the capture or video picels in row #2. FIG. 8E illustrates a timing diagram of the schemes shown in FIG. 8C at time t2. In FIG. 8E, at time t1, a third pulse train signal is triggered where a width of the pulse is long enough to activate only the capture or video picels in row #1. At time t1+d, where d is the width of the pulse of the second train signal where the capture or video picel is active, a fourth pulse train signal is triggered where a width of the pulse is long enough to activate only the RGB picels in row #2. Those skilled in the art will appreciate that the timings of the first and second train signals may be modified to provide alternative schemes to display or capture information.

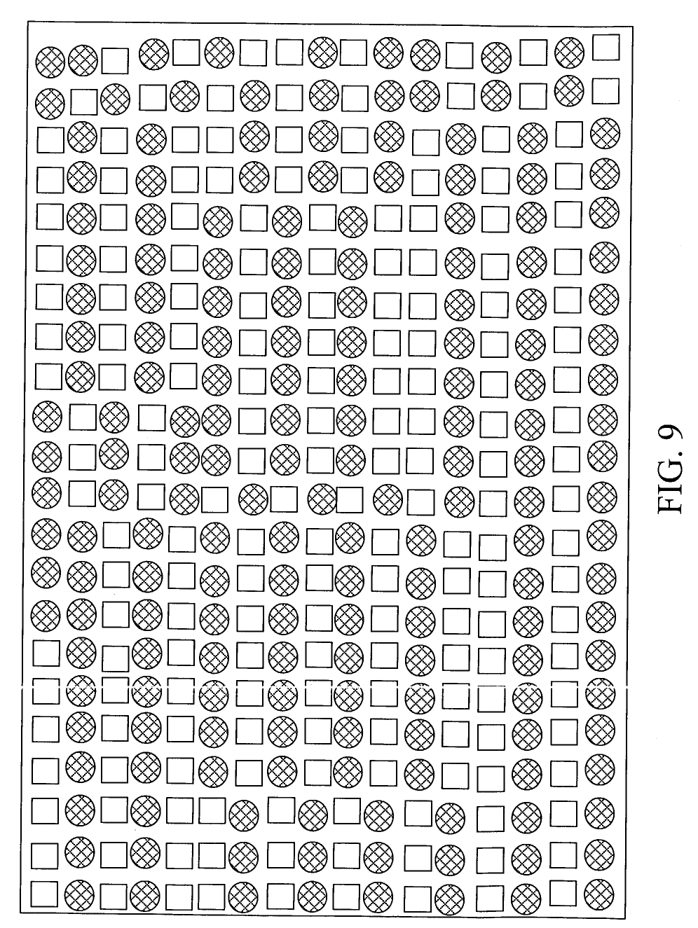

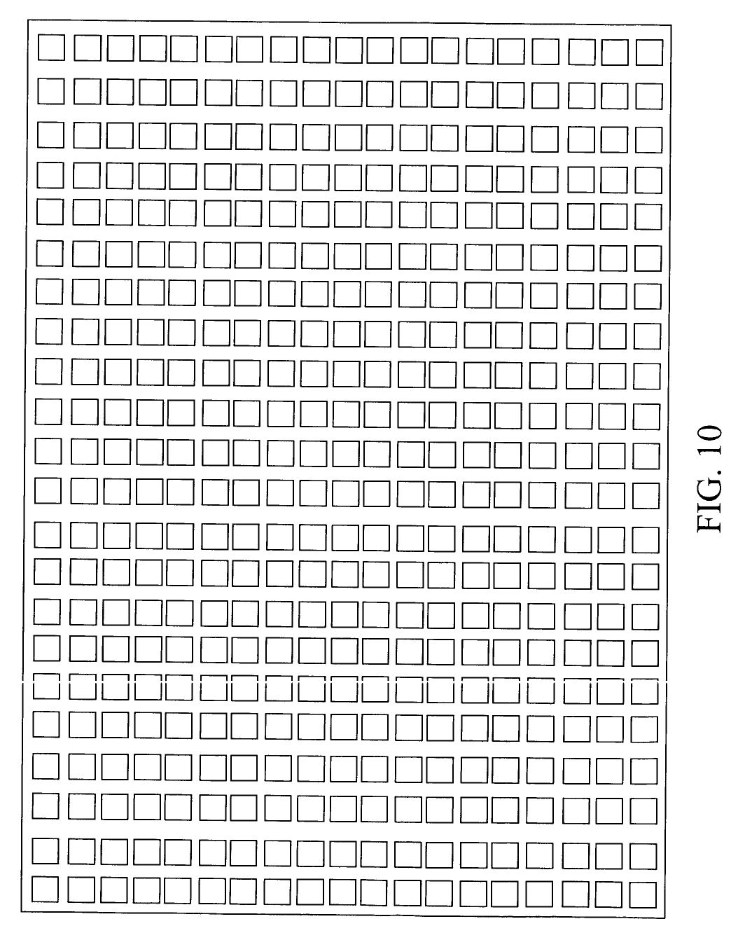

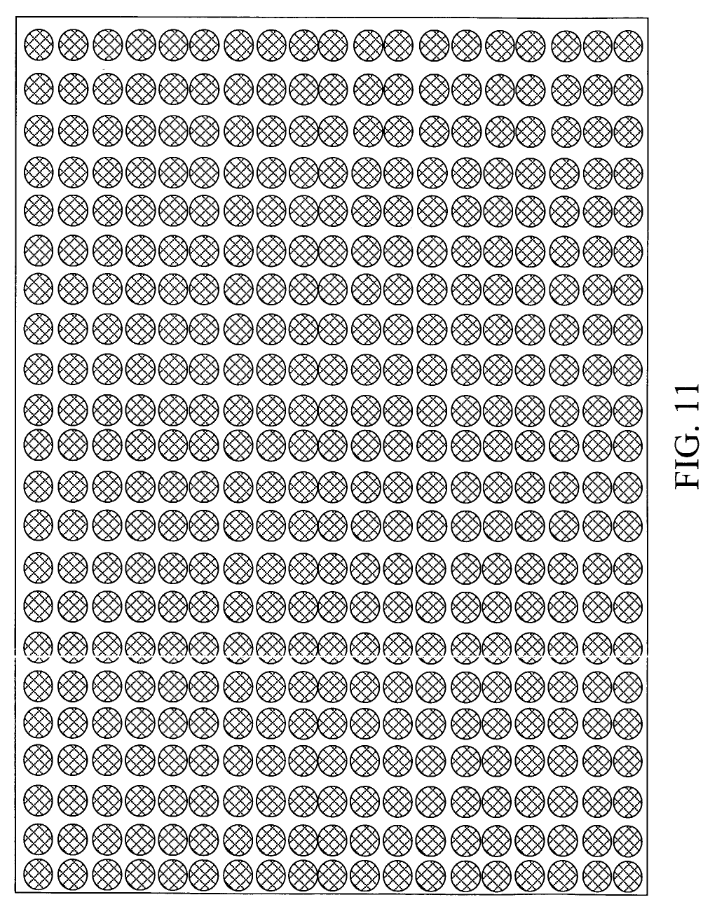

FIG. 9 illustrates a scheme where, for each row, a consecutive number of pixels (squares) are randomly selected to be in the capture mode and a consecutive number of pixels (circles) are randomly selected to be in the display mode. The consecutive number of pixels in the capture or display mode may vary between rows. FIG. 10 illustrates the video capture monitor being entirely in the capture mode. FIG. 11 illustrates the video capture monitor being entirely in the display mode.

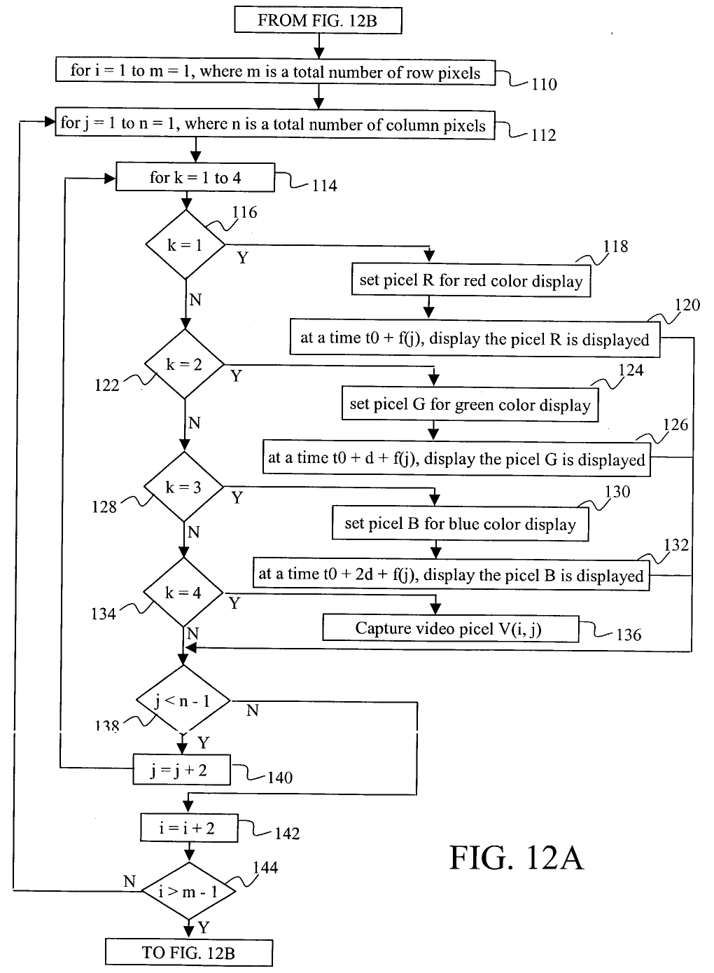

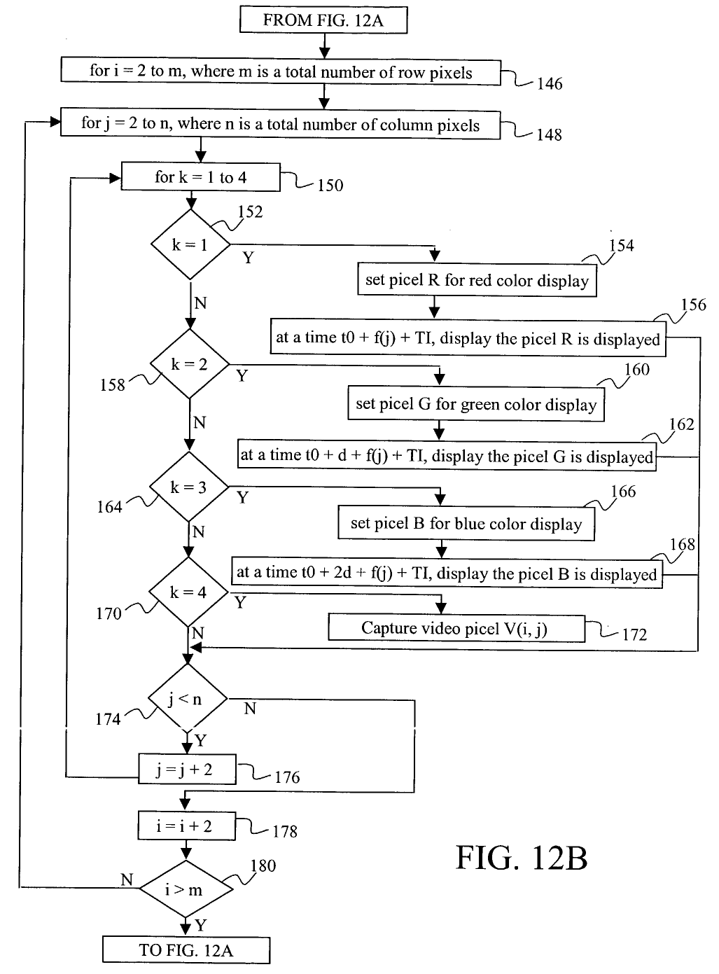

FIG. 12 illustrates a display/capture method, in accordance with an aspect of the present invention. For illustrative purposes, the method illustrates the processing of the pixels in the display and capture mode where the pixel columns and the pixel rows are processed in an alternating manner. However, those skilled in the art will appreciate that the method may be modified to process the pixels to display and/or capture the information in alternative ways.

At operation 110, the method starts and a pointer i is initialized, for i=1 to m−1, where m is a total number of pixel rows. At operation 112, a pointer j is initialized, for j=1 to n−1, where n is a total number of pixel columns. At operation 114, for k=1 to 4, where k controls the color output of the RGB picels and the capture picel, where, at operation 116, if k=1, at operation 118, picel R is set for a red color display. And, at operation 120, at a time t0+f(j), the picel R is displayed and the method proceeds to operation 138, where t0 is a preset time and f(j) is a time period where an on-time scan is performed. Otherwise, from operation 116, the method proceeds to operation 122, where if k=2, at operation 124, picel G is set for a green color display. At operation 126, at a time t0+d+f(j), the picel G is displayed and the method proceeds to operation 138, where d is a factor indicative of a processing speed of the controller.

At operation 128, if k=3, at operation 130, picel B is set for a blue color display. At operation 132, at a time t0+2d+f(j), the picel B is displayed and the method proceeds to operation 138. Otherwise, from operation 128, the method proceeds to operation 134, where if k=4, the capture or video picel is captured as V(i, j) and the method proceeds to operation 138. At operation 138, if the number of column pixels, j, is less than n−1, at operation 140, the method increments a present pixel column position by two, thus, processing the pixel columns in an alternating manner, and the method loops back to operation 114. However, if the number of column pixels, j, is greater than n−1, at operation 142, the method increments a present pixel row position by two and, at operation 144, if the increment of the row position is less than m−1, then the method returns to operation 112 to repeat the scanning of the odd pixel columns. Accordingly, operations 110 and 144 are performed to process the odd pixel columns and rows of the video capture monitor. If, however, at operation 144, the increment of the row position is greater than m−1, then the method proceeds to operation 150 of FIG. 12B to process the even pixel columns and pixel rows of the video capture monitor.

At operation 146, the method the pointer i is initialized, for i=2 to m, where m is the total number of pixels rows. At operation 148, the pointer j is initialized, for j=2 to n, where n is the total number of pixel columns. At operation 150, for k=1 to 4, where, at operation 152, if k=1, at operation 154, picel R is set for red color display. And, at operation 156, at a time t0+f(j)+TI, the picel R is displayed and the method proceeds to operation 174, where to is the preset time, f(j) is the time period where the on-time scan is performed, and TI is a total time for the odd and even pixel columns and rows to be processed. If k is not equal to 1, at operation 158, a determination is made whether k=2. If k=2, at operation 160, picel G is set for green color display. At operation 162, at a time t0+d+f(j)+TI, the picel G is displayed and the method proceeds to operation 174, where d is a factor indicative of a processing speed of the controller. If k is not equal to 2, at operation 164, if k=3, at operation 166, picel B is set for blue color display. At operation 168, at a time t0+2d+f(j)+TI, the picel B is displayed and the method proceeds to operation 174.

If k is not equal to 3, at operation 170, a determination is made whether k=4. If k=4, then at operation 172, the capture or video picel is captured as V(i, j) and the method proceeds to operation 174. At operation 174, if the number of column pixels, j, is less than n, at operation 176, the method increments a present column position by two, thus, processing the pixel columns in an alternating manner, and loops back to operation 150. However, if the number of column pixels, j, is greater than n, at operation 178, the method increments a present row position by two and, if at operation 180, if the increment of the row position is less than m, then the method returns to operation 148 to repeat the scanning of the even pixel columns. Otherwise, the method returns to operation 112 of FIG. 12A.

According to an aspect of the present invention, pixels displaying images or information on a monitor or a screen are provided to further capture images with the monitor. Each pixel includes at least four picels, for instance, where three picels provide red, green, and blue colors to display the information on the monitor and a fourth picel acquires the image before the monitor. Specifically, each pixel has two functions: a first function is to display image information in a conventional manner, and a second function is to act as an active element by acquiring or capturing, for instance, a projected image of the target, such as a person, before the monitor. Therefore, the pixels act as a hidden video camera acquiring the image of the person in front of the monitor. Furthermore, in accordance with an aspect of the present invention, while acquiring the video imagery, the pixels are interlaced where at some instant of time, while some pixels function in a display mode where information is being displayed, other pixels function in a capture mode where the image of the person is acquired. Subsequently, according to a predefined interlacing scheme, the pixels reverse their associated function where the pixels displaying the information change to acquire the image of the person and vice-versa, thereby assuring a quality of both, the image or the information displayed and that acquired.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A video capture monitor, comprising:
pixels, each displaying information on the video capture monitor and capturing an image with the video capture monitor.

2. The video capture monitor as recited in claim 1, wherein each pixel comprises four picels, where three picels provide red, green, and blue colors to display the information on the video capture monitor and a fourth picel (capture picel) captures the image.

3. The video capture monitor as recited in claim 1, wherein the pixels are interlaced where at some instant of time, a set of pixels function in a display mode where information is being displayed, and another set of pixels function in a capture mode where the image is captured.

4. The video capture monitor as recited in claim 2, further comprising:
a controller to process the captured image and/or to display the information, the controller comprising
a red picels controller, a green picels controller, and a blue picels controller to control the red, green, and blue picels, respectively, of the pixels,
a photoelectronic array controller to control the capture picels of each pixel of the video capture monitor, and
a display controller to control the red, green, and blue picels controllers and the photoelectronic array controller.

5. The video capture monitor as recited in claim 1, wherein the video capture monitor saves the captured image in files or uploads the captured image to a remote monitor over a network.

6. The video capture monitor as recited in claim 1, wherein the video capture monitor is a local video capture monitor capturing the image, displaying the image, and transmitting the image to remote video capture monitors connected to the local video capture monitor via a network.

7. The video capture monitor as recited in claim 1, wherein odd pixels in odd pixel rows and even pixels in even pixel rows of the video capture monitor display the information, and the even pixels in the odd pixel rows and the odd pixels in the even pixel rows capture the image in an alternating time sequence.

8. The interlace monitor as recited in claim 7, wherein each pixel comprises RGB picels and a capture picel, where the RGB picels of the odd pixels of the odd pixel rows and of the even pixels of the even pixel rows of the video capture monitor, are displaying R (Red), G (Green), and/or B (Blue) colors at different intensities of the information and the capture picels are inactive, and the capture picels of the even pixels of the odd pixel rows and of the odd pixels of the even pixel rows are capturing the image and the RGB picels are inactive.

9. The video capture monitor as recited in claim 1, wherein the odd and even pixel rows of the video capture monitor alternate between displaying the information and capturing the image, respectively.

10. The video capture monitor as recited in claim 1, wherein the odd and even pixel columns of the video capture monitor alternate between displaying the information and capturing the image, respectively.

11. The video capture monitor as recited in claim 1, wherein, in an alternating sequence, a consecutive number of pixels are randomly selected to be capturing the image and a consecutive number of pixels are randomly selected to be displaying the information.

12. The video capture monitor as recited in claim 1, wherein the interlaced screen is entirely in the capture mode or in the display mode.

13. A video capture monitor, comprising:
pixels displaying R (Red), G (Green), and/or B (Blue) colors of information at different intensities in alternating pixel rows or columns, wherein each pixel comprises four picels, where three picels provide red, green, and blue colors to display the information on the video capture monitor and a fourth picel (capture picel) captures an image with the monitor.

14. The video capture monitor as recited in claim 13, wherein the pixels are interlaced where at some instant of time, a set of pixels function in a display mode where information is being displayed, and another set of pixels function in a capture mode where the image is captured.

15. The video capture monitor as recited in claim 13, wherein odd pixels in odd pixel rows and even pixels in even pixel rows of the video capture monitor display the information, and the even pixels in the odd pixel rows and the odd pixels in the even pixel rows capture an image with the video capture monitor in an alternating time sequence.

16. The interlace monitor as recited in claim 15, wherein each pixel comprises RGB picels and a capture picel, where the RGB picels of the odd pixels of the odd pixel rows and of the even pixels of the even pixel rows of the video capture monitor, are displaying the R (Red), G (Green), and/or B (Blue) colors and the capture picel is inactive, and the capture picel of the even pixels of the odd pixel rows and of the odd pixels of the even pixel rows is capturing the image and the RGB picels are inactive.

17. A video capture monitor displaying information and capturing an image with the video capture monitor, comprising:
a scanner/color decoder determining R (Red), G (Green), and/or B (Blue) picel values and color distribution of the information to be displayed;
a trigger/time reference triggering time sequences to control the pixel rows and columns in the video capture monitor to display the information;
a projection-on-screen and capturing picels circuit capturing the image with the video capture monitor;
a photoarray color resolution (R, G, B) circuit breaking the captured image into RGB components; and
a display/capture scheme receiving the RGB picel values of the information to be displayed and the RGB components of the captured image to display the information and the captured image.

18. A method of a video capture monitor, comprising:
displaying information on the video capture monitor and capturing an image with the video capture monitor using pixels of the video capture monitor, wherein at some instant of time, some pixels function in a display mode where information is being displayed, and other pixels function in a capture mode where the image is captured.

19. A method of for capturing video information with a monitor, comprising:
determining R (Red), G (Green), and/or B (Blue) picel values and color distribution of information to be displayed;
triggering time sequences to control the pixel rows and columns in the monitor to display the information;
capturing the image with the monitor;
breaking the captured image into RGB components; and
receiving the RGB picel values of the information to be displayed and the RGB components of the captured image to display the information and the captured image.
